(19) United States
(12) Patent Application Publication
(10) Pub. No.: US 2011/0244732 A1
(43) Pub. Date: Oct. 6, 2011

(54) ELECTRICAL CONNECTOR WITH WELL ELECTRICAL CONNECTION PERFORMANCE

(75) Inventor: YU ZHU, Shenzhen (CN)

(73) Assignee: HON HAI PRECISION INDUSTRY CO., LTD., Tu-Cheng (TW)

(21) Appl. No.: 12/917,507

(22) Filed: Nov. 2, 2010

(30) Foreign Application Priority Data
Mar. 31, 2010 (CN) 201020146326.2

(51) Int. Cl. H01R 24/00; H01R 13/11

(52) U.S. Cl. 439/660; 439/850

(57) ABSTRACT

An electrical contact includes a pair of parallel spaced contacting arms. Each contacting arm defines a first spring section and a second spring section symmetrically defined. A first connecting portion unitarily connects with the first spring sections of the pair of the contacting arms and a second connecting portion unitarily connects with the second spring sections of the pair of the contacting arms. The first and second connecting portions respectively define a tuber protruding to touch with each other so as to improving the current intensity.

### BACKGROUND OF THE INVENTION

1. Field of the Invention

The present invention generally relates to an electrical connector, and more particularly, to a novel structure of an electrical contact with a plurality of contacts for improving signal transmission.

2. Description of Related Art

An electrical contact as shown in U.S. Pat. No. 4,943,248, includes a pair of U-shaped contact arms disposed in spaced relationship to define a blade receiving slot therebetween for receiving a blade contact. The receiving slot is contacted on its first side by the first U-shaped structure and on its second side by the second U-shaped structure. Each U-shaped structure includes first and second contact portions and a connecting portion extending therebetween. The two connecting portions of the first and second U-shaped structure are parallel spaced with each other. The contact is formed by a continuous strip of thin metal and very small in fact. The electric current transmitted by the contact is weak, as a result it influences signal transmission. Thus, an electrical connector with a plurality of contacts for improving signal transmission is desired to overcome the disadvantages of the related art.

Hence, the present invention is directed to solving this problem in the related art.

### SUMMARY OF THE INVENTION

An object of the invention is to provide an electrical connector which has a plurality of contacts for improving signal transmission.

In order to achieve the object set forth, an electrical contact includes a pair of parallel spaced contacting arms. Each contacting arm defines a first spring section and a second spring section symmetrically defined. A first connecting portion unitarily connects with the first spring sections of the pair of the contacting arms and a second connecting portion unitarily connects with the second spring sections of the pair of the contacting arms. The first and second connecting portions respectively define a tuber protruding to touch with each other so as to improving the current intensity.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of an electrical connector of an embodiment of the present invention;

FIG. 2 is a view similar to FIG. 1, while taken from a different aspect;

FIG. 3 is an exploded perspective view of the electrical connector as shown in FIG. 1;

FIG. 4 is an exploded perspective view of the electrical connector as shown in FIG. 2; and

FIG. 5 is a perspective view of a contact of the electrical connector as shown in FIG. 1.

### DETAILED DESCRIPTION OF THE INVENTION

Reference will now be made in detail to the preferred embodiment of the present invention.

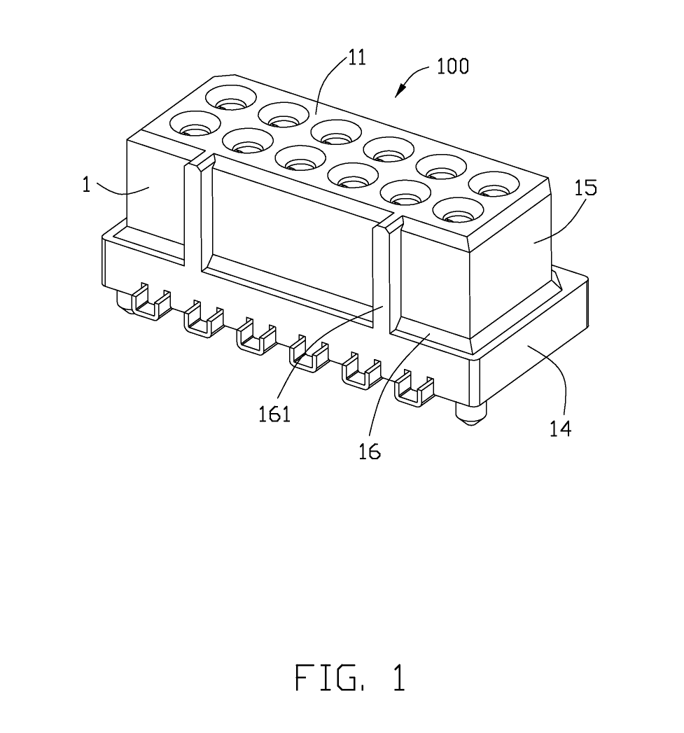

Referring to FIGS. 1-5, an electrical connector 100 in accordance with an embodiment of the present invention comprises an insulative housing 1 and a plurality of similar electrical contacts 2 each adapted to be secured in a passageway 13.

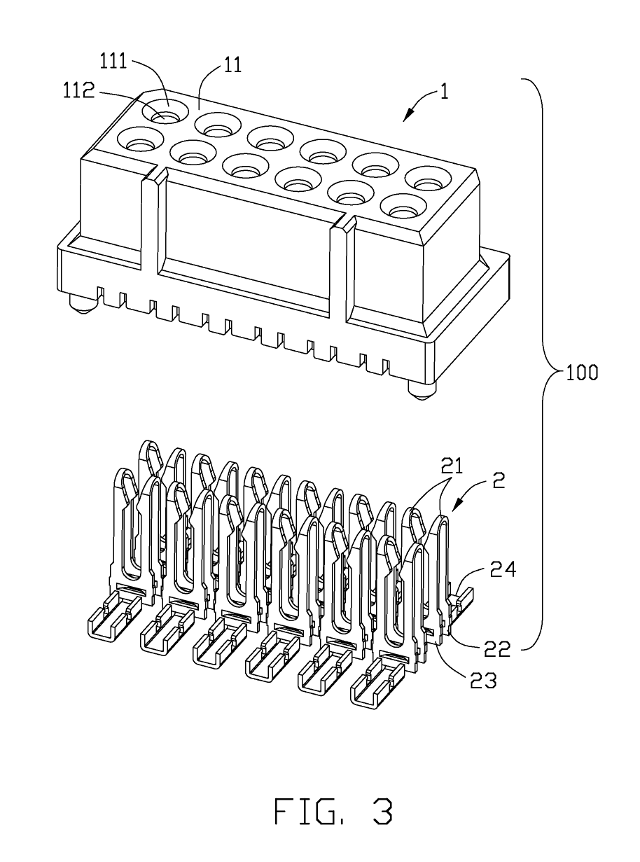

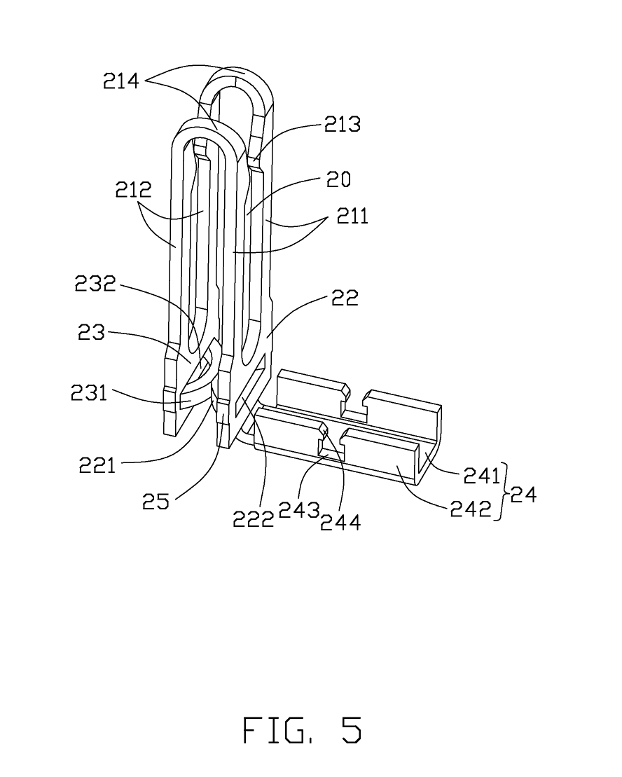

Referring to FIG. 5, the contact 2 includes a pair of parallel U-shaped contacting arms 21 (labeled in FIG. 3) disposed in spaced relationship to define a receiving slot 20 therebetween for connecting with a complementary blade contact (not shown). The receiving slot 20 is contacted on its first side by a first U-shaped structure and on its second side by a second U-shaped structure. Each contacting arm 21 defines symmetrical first and second spring sections 211, 212 and a curve portion 214 unitarily connecting with the first and second spring sections 211, 212. A pair of convex contact points 213 is respectively defined at the first and second spring section 211, 212 and extends into the receiving slot 20 and generally toward the opposed U-shaped structure. The first U-shaped structure is formed by the two first spring sections 211 of the pair of the contacting arms 21 and a first connecting portion 22 unitarily connecting with the two first spring sections 211. The second U-shaped structure is formed by the two second spring sections 212 of the pair of the contacting arms 21 and a second connecting portion 23 unitarily connecting with the two second spring sections 212. The first and second connecting portions 22, 23 respectively define an punched arcuate tuber 221, 231 protruding to touch with each other and a hole 222/232 of which the tuber 221/231 connects with two sides ends. Therefore, power current can flow through the first and second spring sections 211, 212, which constitute a parallel circuit and the resistance of the contact 2 become smaller as known, as a result the signal transmission of the contacts 2 is improved.

In the illustrated embodiment of the invention, the contact 2 further includes a soldering portion 24 extending from a bottom end of the first connecting portion 22 perpendicularly, which includes a horizontal portion 241 perpendicular to the first connecting portion 22 and a pair of side portions 242 extending uprightly at two sides of the horizontal portion 241. The first and second connecting portions 22, 23 are defined at the same side of the horizontal portion 241. Each side portion 242 defines a cutout 243 recessed downwards to the horizontal portion 241 and a pair of first engagement portions 244 defined at two sides of the opening of the cutout 243. A plurality of second engagement portions 25 are respectively defined at two sides of the first and second connecting portions 22, 23 for securely retaining the contact 2 in the passageway 13.

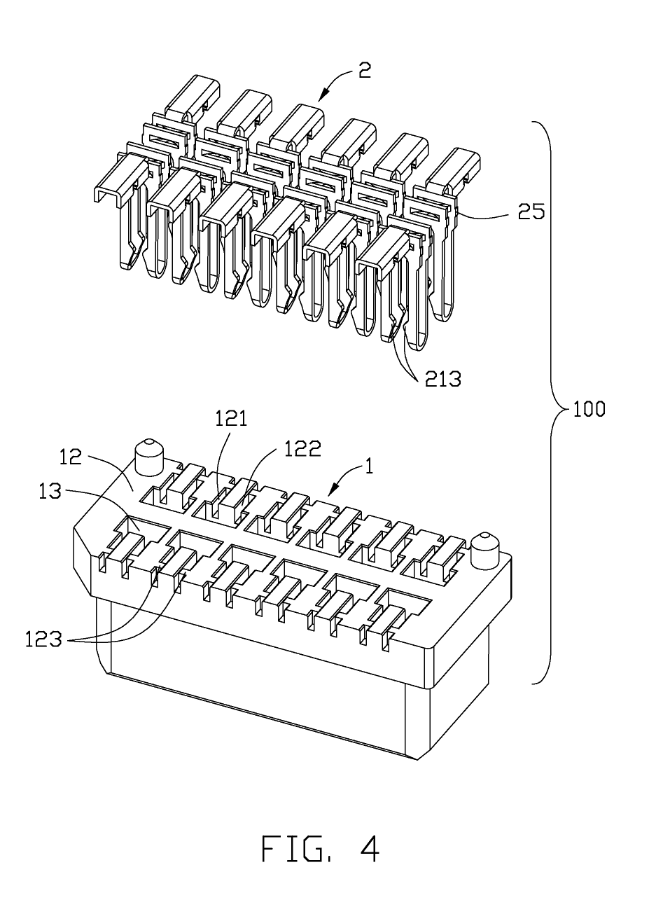

Referring to FIGS. 3 and 4, the insulative housing 1 includes a mating face 11 for confronting with a complementary connector (not shown) and a mounting face 12 opposite to the mating face 11 to confront with a PCB. The plurality of passageways 13 extend through the mating face 11 and the mounting face 12 for receiving the contacts 2. A base 14 extends upwardly from the mounting face 12 and a mating portion 15 projects upwardly from the base 14 to define the mating face 11 perpendicular to a vertical direction. A step 16 is directed with the base 14 and the mating portion 15 and defines a pair of first ribs 161 extending upwardly and connecting with a side face of the mating portion 15 for guiding the electrical connector 100 into a cavity of the complementary connector. Each passageway 13 extends upwardly to form a circle open 112 and a circle guiding oblique face 111 connects with the open 112 and the mating face 11 so as to guide the complementary contact to be inserted into the passageway 13. Two parallel spaced recesses 121, 122 extend through one same side of each passageway 13 in perpendicular to the vertical direction and recessed from the mounting face 12 for retaining the soldering portion 24 of the contact 2. Each recess 121/122 defines a second rib 123 at the middle portion thereof to be interfered in the cutout 243 of the soldering portion 24.

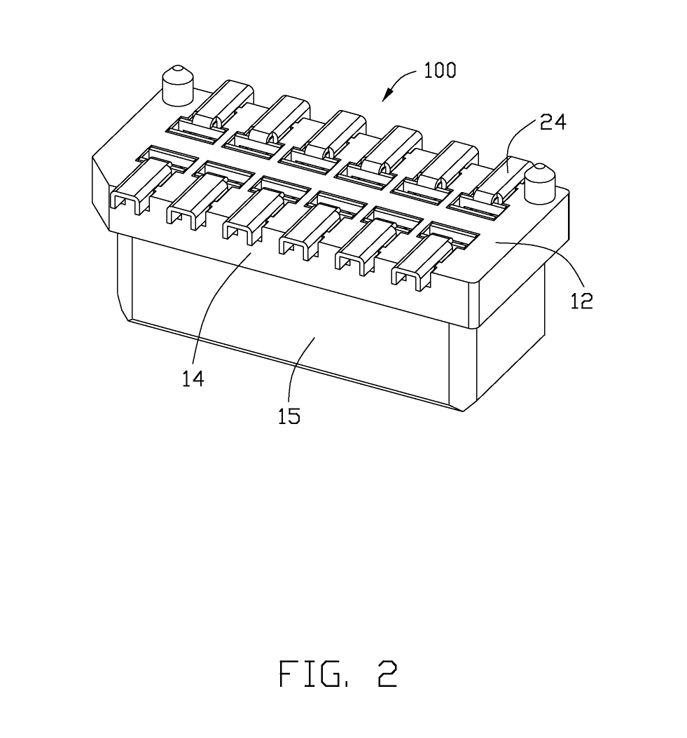

Referring to FIGS. 1 and 2, the contacts 2 are inserted into the passageways 13 from the mounting face 12. The pair of contacting arms 21 is received in the passageway 13 adjacent to the mating face 11. And the first and second connecting portions 22, 23 are retained in the passageway 13 by the second engagement portion 25 and adjacent to mounting face 12. The soldering portion 24 is assembled at the outside of the passageway 13 and the two side portions 242 are respectively retained in the two recesses 121, 122. The cutout 243 is secured on the second rib 123 by the first engagements 244. The horizontal portion 241 is parallel to the mounting face 11 for soldering on a printed circuit board (not shown).

What is claimed is:

1. An electrical contact comprising:
a pair of parallel spaced contacting arms, each contacting arm defining a first spring section and a second spring section symmetrically defined;
a first connecting portion unitarily connecting with the first spring sections of the pair of the contacting arms; and
a second connecting portion unitarily connecting with the second spring sections of the pair of the contacting arms;
wherein the first and second connecting portions respectively define a tuber protruding to touch with each other.

2. The electrical contact as claimed in claim 1, wherein a soldering portion extends from a bottom end of the first connecting portion perpendicularly, which comprises a horizontal portion and a pair of side portions extending uprightly at two sides of the horizontal portion, the first and second connecting portions are defined at a same side of the horizontal portion.

3. The electrical contact as claimed in claim 2, wherein each side portion defines a cutout recessed to the horizontal portion and first engagement portions defined at two sides of the cutout, the first and second connecting portions define second engagement portions respectively at two sides of the first and second connecting portions.

4. The electrical contact as claimed in claim 3, wherein a curve portion unitarily connects with the first and second spring sections of each of the pair of the contacting arms, each contacting arm is U-shaped.

5. The electrical contact as claimed in claim 4, wherein said a receiving slot is defined between the pair of contacting arms, each contacting arm defines convex contacting points protruding in the receiving slot from opposite directions.

6. An electrical connector comprising:
an insulative housing defining a plurality of passageways;
a plurality of contacts secured in the passageways, each contact includes a pair of spaced and parallel flat sections unitarily connecting with each other at a first ends and a soldering section unitarily connecting with a second end opposite to the first end of a first one of the flat sections, a second one of the flat sections pressing against said second end of the first one of the flat section at a second end thereof;
the pair of the flat sections commonly defining a receiving slot for receiving a complementary contact.

7. The electrical connector as claimed in claim 6, wherein the second one of the flat sections is punched with an arc tuber pressing against the second end of the first one of the flat sections.

8. The electrical connector as claimed in claim 7, wherein the contact defines contacting convexes protruding to the receiving slot in a direction perpendicular to a projecting direction of the arc tuber.

9. The electrical connector as claimed in claim 8, wherein the first one of the flat sections is punched with an arc tuber pressing against the arc tuber of the second one of the flat sections.

10. The electrical connector as claimed in claim 7, wherein the receiving slot is formed by transversely splitting the pair of the flat sections from said first end to the second end, but not through the second end.

11. An electrical connector comprising:
an insulative housing defining a plurality of passageways extending therethrough in a vertical direction;
a plurality of contacts disposed in the passageways, respectively,
each of said contacts including a reversed U-shaped configuration in the corresponding passageway, said U-shaped configured including a pair of arms spaced from each other while linked via a bight which is located around a top portion of the housing, a cutout formed in the U-shaped configuration to form a receiving space; and
said pair of arms forming arcuate tubers extending toward and abutting against each other around a bottom portion of the housing; and
each of said contacts further including a tail around said bottom portion of the housing.

12. The electrical connector as claimed in claim 11, wherein each arm further includes a contacting protrusion extending into the cutout around the top portion of the housing.
